(19) United States
(12) Patent Application Publication
(10) Pub. No.: US 2003/0013792 A1
(43) Pub. Date: Jan. 16, 2003

(54) Thermoplastic polyurethane moulding compound

(76) Inventors: Horst Muhlfeld, Grasellenbach (DE); Silke Wagener, Weinheim (DE); Erich Christoph, Obertshausen (DE); Siegfried Nyssen, Straubing (DE)

Correspondence Address: KENYON & KENYON, ONE BROADWAY, NEW YORK, NY, 10004, US

(21) Appl. No.: 10/170,668

(22) Filed: Jun. 12, 2002

Related U.S. Application Data
(63) Continuation of application No. 09/976,190, filed on Oct. 11, 2001.

(30) Foreign Application Priority Data
Oct. 11, 2000 (DE) DE 100 50 495.7

(51) Int. Cl. C08K 5/04; C08K 5/09; C08K 5/01

(52) U.S. Cl. 524/394; 524/487; 524/275

(57) ABSTRACT

Thermoplastic polyurethane moulding compounds, which contain easy-to-remove byproducts capable of migration and exhibiting a high light fastness, are obtained by the reaction of one or several aliphatic polyols having a molecular weight of 450 to 4000 g/mol and an OH number of 20 to 235, selected from the group polyadipates, polycaprolactones, polycarbonates, polytetrahydrofuran and corresponding copolymers or their mixtures, with l,6-hexamethylene diisocyanate and/or hydrogenated dicyclohexylmethane diisocyanate as well as a chain extender selected from the group 1,5-pentanediol, 1,6-hexanediol, 1,4-cyclohexanediol, 1,4-bis(hydroxymethyl)cyclohexane and bis-(hydroxyethyl)hydroquinone in an equivalence ratios of the 1,6-hexamethylene diisocyanate to the polyol of 1.5:1 to 14.0:1, whereby the NCO number, formed from the quotient of the equivalence ratio multiplied by 100 of isocyanate groups to the sum of the hydroxyl groups of polyol and chain extender, lies in the range of 96 to 105, and which contains, as further additives, 0.3 to 5% by wt. of an additive selected from the group of the ester waxes, polyolefin waxes, metallic soaps, amide waxes, fatty acid amides and mixtures thereof, 0.1 to 3% by wt of an UV light absorbed 0.1 to 5% by wt. of a light stabiliser, 0.05 to 2% by wt. of an antioxidant and, optionally, up to 10% by wt. of a color pigment or color batch, in each case related to the total amount of polyurethane.

### RELATED APPLICATIONS

This application is a continuation of prior U.S. application Ser. No. 09/976,190, filed Oct. 11, 2001.

### BACKGROUND OF THE INVENTION

1. Field of the Invention

The present invention relates to a thermoplastic polyurethane moulding compound which contains easy-to-remove by-products capable of migration and exhibits high light fastness

2. Description of Related Art

Thermoplastic polyurethanes (TPUs) which consist of mixtures of various aliphatic polyols and 1,6-hexamethyl diisocyanate with chain extenders such as 1,4-butanediol are known from the documents DE 26 58 136 and DE 42 03 307 The polyurethane moulding compounds described therein can be used in particular for the production of food packaging and for the production of films for decorative purposes Although the polyurethane moulding compounds defined in the patent specifications are suitable for thermoplastic processing methods as regards their melting properties and for the aforementioned applications as regards their strength level, it is a disadvantage, however, for polyurethane moulding compounds to contain cyclic oligourethanes Optical changes, e.g. on the surface of films, may be caused by the migration of these cyclic oligourethanes.

The document DE 199 40 014 describes light-fast and heat-stable thermoplastic polyurethanes (TPUs) which satisfy high optical requirements and still provide mouldings which only exhibit minimum formation of a layer after an accelerated ageing test at 60° C. to 90° C. In long-time tests, i.e. storage of samples at room temperature for at least 100 days and storage of samples in a steam-saturated atmosphere for a period of 28 days at 48° C., the migration process and the formation of a white layer are considerably accelerated and, in the case of the aforementioned TPUs, white layers appear an the surface of the samples which result in a considerable change in color and in dulling of the samples. This is extremely undesirable for most applications as the substances separating on the surface as a white layer can only be removed with difficulty or not at all.

### SUMMARY OF THE INVENTION

It is an object of the invention to develop a thermoplastic polyurethane moulding compound which contains easy-to-remove by-products capable of migration and exhibits high light fastness. This and other objects of the invention are achieved by a thermoplastic polyurethane moulding compound which is obtained by the reaction of one or several aliphatic polyols having a molecular weight of 450 to 4000 g/mol and an OH number of 20 to 235, selected from the group polyadipates, polycaprolactones, polycarbonates, polytetrahydrofuran and corresponding copolymers or their mixtures, with 1,6-hexamethyl diisocyanate and/or hydrogenated dicyclohexylmethane diisocyanate (H₁₂-MDI) as well as a chain extender, selected from the group 1,5-pentanediol, 1,6-hexanediol, 1,4-cyclohexanediol, 1,4-bis(hydroxymethyl)cyclohexane and bis-(hydroxyethyl)hydroquinone in an equivalence ratio of the 1,6-hexamethylene diisocyanate to the polyol of 1.5:1 to 14.0:1, whereby the NCO number, formed from the quotient of the equivalence ratios multiplied by 100 of isocyanate groups to the sum of the hydroxyl groups of polyol and chain extender, lies in the range of 96 to 105, and which contains, as further additives, 0.3 to 5% by wt. of an additive selected from the group of the ester waxes, polyolefin waxes, metallic soaps, amide waxes, fatty acid amides or their mixtures, 0.1 to 3% by wt. of an UV light absorber, 0.1 to 5% by wt of a light stabiliser, 0.05 to 2% by wt. of an antioxidant and, optionally, up to 10% by wt. of a color pigment or color batch, in each case related to the total amount of polyurethane.

### DETAILED DESCRIPTION OF THE INVENTION

The thermoplastic polyurethane moulding compound is preferably obtained by the use of polyadipates of ethylene glycol, diethylene glycol, propanediol, butanediol, pentanediol, hexanediol, neopentyl glycol, polycaprolactones, polycarbonates, polytetrahydrofuran or combinations thereof, polycaprolactones and copolymers with polycarbonates and polytetrahydrofuran, polypropylene glycol, polyethylene glycol or their mixtures as polyol components.

Thermoplastic polyurethane moulding compounds which are obtained by the use of 1,4-cyclohexanediol, 1,4-bis(hydroxymethyl)cyclohexane and bis-(hydroxyethyl)hydroquinone as chain extenders are particularly preferred

Thermoplastic polyurethane moulding compounds which contain 1.0 to 3.0% by wt. of the additive, related to the total amount of polyurethane, are very particularly preferred The thermoplastic polyurethane moulding compounds advantageously contain montanic acid ester, amide wax, stearyl stearate, calcium stearate and/or metallic-soap-containing fatty acid esters as an additive.

Surprisingly, it was found that a white layer which can be easily and, after a visual inspection, completely removed is formed in the production of aliphatic polyurethane moulding compounds based on polyether and/or polyesterol through the reaction with 1,6-hexamethylene diisocyanate and/or H₁₂-MDI, a chain extender selected from the group 1,5-pentanediol, 1,6-hexanediol, 1,4-cyclohexanediol, 1,4-bis(hydroxymethyl)cyclohexane and bis-(hydroxyethyl)-hydroquinone and in the presence of 0.3 to 5% by wt. of an additive, selected from the group of ester waxes, polyolefin waxes, metallic soaps, amide waxes, fatty acid esters, under the conditions of long-time storage over a period of at least 100 days at room temperature or storage in a steam-saturated atmosphere over a period of at least 28 days at 48° C. A dry cloth or an aqueous surfactant solution is sufficient for cleaning whereas, in the case of polyurethane moulding compounds without the aforementioned additives, the white layer adheres particularly strongly to the surface. Aqueous soap solutions are ineffective for eliminating the white layer. Although it is possible to remove the white layer with special organic solvents, the surface of the mouldings is partially dissolved and damaged with this treatment This can be seen from the distinctive changes in color and lustre of the samples.

The polyurethane moulding compounds obtained in accordance with the present invention do not exhibit, as the following examples show, any mechanical or process disadvantages compared with the known aliphatic thermoplastic polyurethane moulding compounds The crystallisation behaviour for an economic processing method is not seriously affected, either, in particular when 1,4-cyclohexanediol, 1,4-bis(hydroxymethyl)cyclohexane or bis-(hydroxyethyl)-hydroquinone is used as the chain extender Moreover, they have the following advantages:

good processing capability in thermoplastic processing methods such as injection moulding, melt extrusion, melt spinning, sintering or hot-melt adhesion processes.

good crystallisation behaviour, in particular rapid recrystallisation, for economic processing using the above-mentioned methods.

high tensile, tear and tear propagation resistance.

good elastic properties.

high light fastness, i.e. no yellowing under the effect of light.

The white layer may be removed, for example, by simply wiping it away with a dry cloth without damaging the surface. As a result, the optical requirements of the automobile industry placed on light fastness, color fastness, degree of lustre and freedom from a white layer are satisfied.

The present invention is described in detail by the following examples.

### EXAMPLE 1

Composition of the Mixture

50 00 parts by weight of polycarbonatediol with a molecular weight of 2000 and an OH number of 56.0

50 00 parts by weight of polyester based on adipinic acid, neopentyl glycol and hexanediol with a molecular weight of 2000 and an OH number of 56.0

15.57 parts by weight of 1,6-hexanediol

30.00 parts by weight of 1,6-hexamethylene diisocyanate

Production Procedure

Production takes place in a single-stage process. Polycarbonatediol, polyester, 1,6-hexanediol and 1,6-hexamethylene diisocyanate are heated to 80° C. under stirring in a reaction vessel. The temperature rises to 180° C. in roughly 14 minutes owing to the exothermal reaction. At this temperature the product is poured onto a polytetrafluoroethylene film. After about 8 hours the sheet produced can be processed into granulate.

The polyurethane moulding compound has the following melting properties:

Melting point: 160° C.

Melt index to DIN ISO 1133 under 2.16 kg load

measured at 170° C.: 8.9 g/10 min.

measured at 120° C.: 83 g/10 min.

measured at 210° C.: 126 g/10 min.

A 1 mm thick sheet produced with the moulding process has the following properties:

Tensile strength: 46.3 MPa

Elongation at rupture 735%

Tear propagation strength: 102 N/mm.

Compounding of the thermoplastic polyurethane (TPU)

The TPU is mixed with the additives, stabilisers and color pigments in a double-screw kneader:

100.00 parts by weight of TPU granulate

3.00 parts by weight of color batch based on the TPU granulate with a pigment content of 40% by wt.

0.40 parts by weight of UV absorber: 2-(2H-benzotriazole)-4,6-bis(1-methyl-1phenylethyl)phenol

0.50 parts by weight of light stabiliser. dimethyl succinate polymer with 4-hydroxy-2,2,6,6-tatramethyl-1-piparidine ethanol

0.30 parts by weight of antioxidants ethylene-bis(oxyethylene)bis(3-tert.-butyl-4-hydroxy-5(methyl hydrocinnamate)

1.00 part by weight of additive: metallic-soap-containing fatty acid ester

### COMPARATIVE EXAMPLE

A thermoplastic polyurethane was produced analogously to example 1 and compounded with the following components:

100.00 parts by weight of TPU granulate

3.00 parts by weight of color batch based on the TPU granulate with a pigment content of 40% by wt.

0.40 parts by weight of UV absorber, 2-(2H-benzotriazole)-4,G-bis(1-methyl-1 phenylethyl)phenol

0.50 parts by weight of light stabiliser: dimethyl succinate polymer with 4-hydroxy-2,2,6,6-tetramethyl-1-piperidine ethanol

0.30 parts by weight of antioxidants: ethylene-bis(oxyethylene)bis(3-tert.-butyl-4-hydroxy-5(methyl hydrocinnamate)

The TPU moulding compounds according to the example and the comparative example were moulded in the moulding process into 1 mm thick sheets and ground into powder using the cold grinding process 1 mm thick films were produced from the powders using the sintering process.

The moulded sheets and sintered films according to the example and the comparative example exhibited a white layer on the surface after storage for 100 days at room temperature and after storage for 28 days in a steam-saturated atmosphere at 48° C. In the case of the comparative example the white layer was considerably more pronounced both after the long-time storage and after storage in the steam-saturated atmosphere.

| | | |
|---|---|---|
| Cleaning procedure | Example after storage | Comparative example after |
| | at RT and in H₂O | storage at 48° C. and in an |
| | atmosphere | H₂O atmosphere |
| Wiping with a | White layer can be | White covering cannot be |
| dry cloth | removed completely, | removed, surface stained |
| | no colour change | |
| | on the surface | |
| Wiping with a | White layer can be | White layer cannot be |
| soap solution | completely removed, | completely removed, |
| | no colour change on | surface stained, dull |
| | the surface | |
| Wiping with | White layer can be | White layer cannot be |
| isopropanol | removed completely, | completely removed, |
| | no colour change | surface stained, |
| | on the surface | dull |
| Wiping with | no inspection | Partial dissolution of the |
| tetrahydroufuran | | surface, change in colour, |
| | | stained |
| Wiping with | no inspection | Partial dissolution of the |
| dimethylformamide | | surface, change in colour, |
| | | stained |

What is claimed is:

1. A thermoplastic polyurethane moulding compound with a high light fastness, comprising the reaction product of at least one aliphatic polyol having a molecular weight of 450 to 4000 g/mol and an OH number of 20 to 235, selected from the group consisting of polyadipates, polycaprolactones, polycarbonates, polytetrahydrofuran and corresponding copolymers and mixtures thereof, with 1,6-hexamethyl diisocyanate or hydrogenated dicyclohoxylmethane diisocyanate (H₁₂-MDI) as well as a chain extender selected from the group consisting of 1,5-pentanediol, 1,6-hexanediol, 1,4-cyclohexanediol, 1,4-bis(hydroxymethyl)cyclohexane and bis-(hydroxyethyl)hydroquinone in an equivalence ratio of the 1,6-hexamethylene diisocyanate to the polyol of 1.5:1 to 14.0:1, whereby the NCO number, formed from the quotient of the equivalence ratio multiplied by 100 of isocyanate groups to the sum of the hydroxyl groups of polyol and chain extender, is from 96 to 105, and further comprising 0.3 to 5% by wt. of an additive selected from the group consisting of ester waxes, polyolefin waxes, metallic soaps, amide waxes, fatty acid amides and mixtures thereof, 0.1 to 3% by wt. of an UV light absorber, 0.1 to 5% by wt of a light stabiliser, and 0.05 to 2% by wt. of an antioxidant, in each case relative to the total amount of polyurethane.

2. The thermoplastic polyurethane moulding compound according to claim 1, further comprising up to 10% by wt. of a color pigment or color batch.

3. The thermoplastic polyurethane moulding compound according to claim 1, wherein the polyol is selected from the group consisting of: polyadipates of ethylene glycol, diethylene glycol, propanediol, butanediol, pentanediol, hexanediol, neopentyl glycol, polycaprolactones, polycarbonates, polytetrahydrofurans and mixtures thereof, polycaprolactones and copolymers with polycarbonates and polytetrahydrofuran, polypropylene glycol, polyethylene glycol and mixtures thereof.

4. The thermoplastic polyurethane moulding compound according to claim 1, wherein 1,4-cyclohexanediol, 1,4-bis(hydroxymethyl)cyclohexane or bis-(hydroxyethyl)-hydroquinone is used as a chain extender.

5. The thermoplastic polyurethane moulding compound according to claim 3, wherein 1,4-cyclohexanediol, 1,4-bis(hydroxymethyl)cyclohexane or bis-(hydroxyethyl)-hydroquinone is used as a chain extender.

6. The thermoplastic polyurethane moulding compound according to claim 1, wherein the additive comprises 1.0 to 3.0% by wt. of the moulding compound relative to the total amount of polyurethane.

7. The thermoplastic polyurethane moulding compound according to claim 3, wherein the additive comprises 1.0 to 3.0% by wt. of the moulding compound relative to the total amount of polyurethane.

8. The thermoplastic polyurethane moulding compound according to claim 4, wherein the additive comprises 1.0 to 3.0% by wt. of the moulding compound relative to the total amount of polyurethane.

9. The thermoplastic polyurethane moulding compound according to claim 1, wherein the additive is montanic acid ester, amide wax, stearyl stearate, calcium stearate or metallic-soap-containing fatty acid ester.

10. The thermoplastic polyurethane moulding compound according to claim 3, wherein the additive is montanic acid ester, amide wax, stearyl stearate, calcium stearate or metallic-soap-containing fatty acid ester.

11. The thermoplastic polyurethane moulding compound according to claim 4, wherein the additive is montanic acid ester, amide wax, stearyl stearate, calcium stearate or metallic-soap-containing fatty acid ester.

12. The thermoplastic polyurethane moulding compound according to claim 6, wherein the additive is montanic acid ester, amide wax, stearyl stearate, calcium stearate or metallic-soap-containing fatty acid ester.

13. A process for producing the thermoplastic polyurethane moulding compound according to claim 1, wherein the additives are worked into the polyurethane compound.

14. A process of using the thermoplastic polyurethane moulding compound according to claim 1 in a powder-slush process.
